(19) United States
(12) Patent Application Publication
(10) Pub. No.: US 2024/0227093 A9
(43) Pub. Date: Jul. 11, 2024

(54) OVERLAY WELDING METHOD AND METHOD FOR REPAIRING METAL MEMBER

(71) Applicant: MITSUBISHI HEAVY INDUSTRIES, LTD., Tokyo (JP)

(72) Inventors: Ryoji FUSHINO, Tokyo (JP); Takuya HIRAOKA, Tokyo (JP); Akito HIGASA, Tokyo (JP); Koji TSUKIMOTO, Tokyo (JP)

(21) Appl. No.: 18/380,405

(22) Filed: Oct. 16, 2023

(30) Foreign Application Priority Data
Oct. 19, 2022 (JP) 2022-167622

(51) Int. Cl. B23P 6/00; B23K 26/064; B23K 26/342

(52) U.S. Cl. CPC B23P 6/007; B23K 26/064; B23K 26/342; B33Y 10/00

(57) ABSTRACT

An overlay welding method includes irradiating a surface of a metal member with a laser beam while supplying a weld metal powder, and performing overlay welding on the surface of the metal member, and repeatedly performing a weld bead formation step of melting and solidifying the weld metal powder with the laser beam to form a plurality of weld beads on the surface of the metal member. Each of the plurality of weld beads has one portion in a width direction overlapping each other. In the overlay welding method, in a case of forming an adjacent weld bead, which is a weld bead adjacent to a previously formed weld bead, an energy density of the laser beam is adjusted to be higher at a portion of the adjacent weld bead overlapping the previously formed weld bead than at a portion not overlapping the previously formed weld bead.

### BACKGROUND OF THE INVENTION

### Field of the Invention

The present disclosure relates to an overlay welding method and a method for repairing a metal member.

Description of Related Art

TIG arc welding is known, for example, as one of the techniques of overlay welding for repairing a metal member in which damage such as thinning or cracking has occurred. In the TIG arc welding, are discharge is continuously generated from an electrode, and a welding rod is fed to a molten pool formed at a repair portion of a metal member to form beads, thereby repairing a portion where damage has occurred.

On the other hand, laser welding with a high energy density is known as one of the techniques of overlay welding, compared to the TIC arc welding. In the laser welding, a range of inputting heat into a metal member is more local than in the TIG arc welding.

In addition, in laser metal deposition (LMD) in which a metal powder is used as a filler metal, the molten pool is smoothly formed compared to the TIG arc welding using the welding rod. Therefore, it does not take long to form beads. Accordingly, the amount of heat input to the metal member relatively decreases. Thus, heat damage such as weld cracks, deformation, or the like is less likely to occur in the metal member.

For example, Japanese Unexamined Patent Application, First Publication No. 2018-167320 discloses a laser overlay welding method. In the laser overlay welding method, one overlay bead having a certain width is formed on a surface of a metal member, and a next overlay bead is formed to be adjacent in a width direction of the preceding overlay bead or to have an end portion in a width direction to overlap. Accordingly, wide overlay beads are formed as a whole.

### SUMMARY OF THE INVENTION

Meanwhile, in the field of laser overlay welding, it is required to suppress the occurrence of fusion failure in a portion where beads overlap each other.

Accordingly, an object of the present disclosure is to provide an overlay welding method capable of suppressing the occurrence of fusion failure in a portion where weld beads overlap each other while suppressing a thermal effect on a metal member, and a method for repairing a metal member.

An overlay welding method as an aspect for achieving the above object is an overlay welding method including irradiating a surface of a metal member with a laser beam while supplying a weld metal powder, and performing overlay welding on the surface of the metal member, in which a weld bead formation step of melting and solidifying the weld metal powder with the laser beam to form a weld bead on the surface of the metal member is repeatedly performed to form a plurality of weld beads on the surface of the metal member, each of the plurality of weld beads has one portion in a width direction overlapping each other, and in a case of forming an adjacent weld bead, which is a weld bead adjacent to a previously formed weld bead, an energy density of the laser beam is adjusted to be higher at a portion of the adjacent weld bead overlapping the previously formed weld bead than at a portion not overlapping the previously formed weld bead.

A method for repairing a metal member as an aspect includes a damaged portion removal step of removing a damaged portion in the metal member, and an overlay welding step of performing the overlay welding method with respect to a surface of the metal member, from which the damaged portion is removed.

According to an aspect of the present invention, it is possible to provide an overlay welding method capable of suppressing the occurrence of fusion failure in a portion where weld beads overlap each other while suppressing a thermal effect on a metal member, and a method for repairing a metal member.

### BRIEF DESCRIPTION OF THE DRAWINGS

FIGS. 1A and 1B are views showing a schematic configuration of a welding device according to an embodiment of the present disclosure. FIG. 1A is a conceptual view showing a schematic configuration of a whole welding device and FIG. 1B is a view of a welding head seen in a direction of a line B-B of FIG. 1A.

FIG. 2 is a view showing a state when a welding device forms a weld bead on a surface of a metal member according to the embodiment of the present disclosure.

FIG. 3 is a flowchart showing a method for repairing a metal member according to the embodiment of the present disclosure.

FIG. 4 is a view showing a damaged portion removal step according to the embodiment of the present disclosure. As shown in (a) of FIG. 4, a state before a damaged portion generated in a metal member is removed. As shown in (b) of FIG. 4, a state after the damaged portion is removed,

FIG. 5 is a view showing a tab disposition step according to the embodiment of the present disclosure. As shown in (a) of FIG. 5, a state before a tab is disposed on a metal member. As shown in (b) of FIG. 5, a state after the tab is disposed.

FIG. 6 is a view showing a weld bead formation step of a first step according to the embodiment of the present disclosure. As shown in (a) of FIG. 6, a state when an initial weld bead formation step of the first step is started. As shown in (b) of FIG. 6, a state when the initial weld bead formation step of the first step ends.

FIG. 7 is a view showing a first step according to the embodiment of the present disclosure. As shown in (a) of FIG. 7, the start of a second weld bead formation step. As shown in (b) of FIG. 7, a state during the second weld bead formation step.

FIG. 8 is a view showing a distribution of energy densities in a width direction of a laser beam emitted from a welding head according to the embodiment of the present disclosure. A portion of (a) in FIG. 8 is a cross sectional view of a weld bead in a direction of a line VIII-VIII of FIG. 7. As shown in (b) of FIG. 8, a distribution of energy densities in a width direction when forming a first weld bead. As shown in (c) of FIG. 8, a distribution of energy densities in a width direction of a weld bead which is secondly formed.

FIG. 9 is a view showing the end of a first step according to the embodiment of the present disclosure.

FIG. 10 is a view showing a second step according to the embodiment of the present disclosure. As shown in (a) of FIG. 10, a state when an initial weld bead formation step is started when forming an initial weld bead group in a second step. As shown in (b) of FIG. 10, a state when the initial weld bead formation step ends when forming the initial weld bead group in the second step.

FIG. 11 is a view showing a cross section in a welding direction of a plurality of weld bead groups formed in a second step according to the embodiment of the present disclosure.

FIG. 12 is a view showing a state after an unnecessary portion is removed in an unnecessary portion removal step according to the embodiment of the present disclosure.

FIG. 13 is a view showing a distribution of energy densities of a laser beam emitted from a welding head according to another embodiment of the present disclosure, and is a view corresponding to a portion shown in FIG. 8.

FIG. 14 is a view showing a distribution of energy densities of a laser beam emitted from a welding head according to another embodiment of the present disclosure, and is a view corresponding to a portion shown in FIG. 8.

### DETAILED DESCRIPTION OF THE INVENTION

Hereinafter, a mode for implementing a method for repairing a metal member according to the present disclosure will be described with reference to the accompanying drawings.

A method for repairing a metal member of the present embodiment is a method for repairing a metal member such as a gas turbine rotor blade or a split ring in which damage such as thinning or cracking has occurred. In the method for repairing the metal member, a metal member is repaired using a welding device capable of performing overlay welding by laser metal deposition (LMD). The metal member of the present embodiment is formed of a metal such as, for example, a Ni-based alloy.

Here, the welding device used in the method for repairing the metal member will be described.

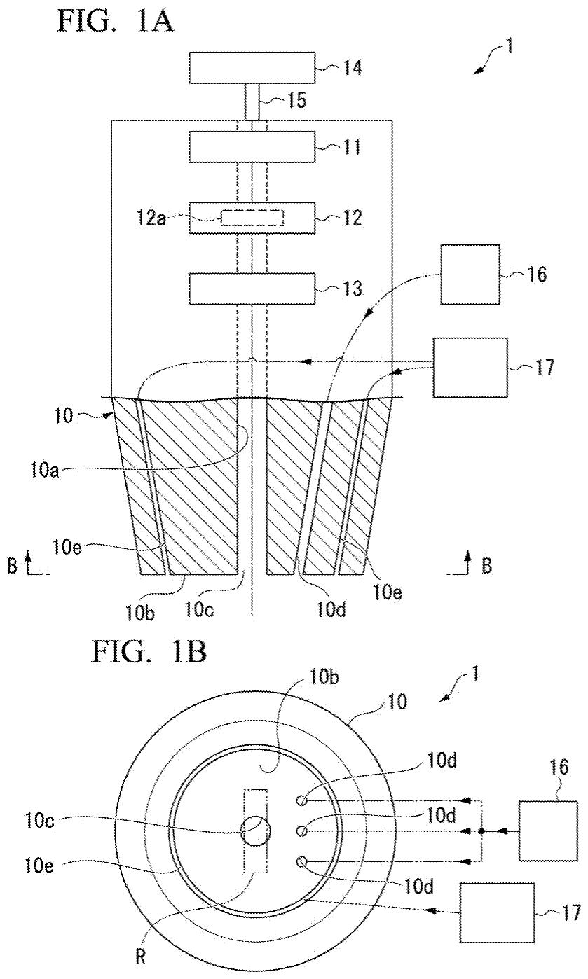

As shown in FIGS. 1A and 1B, a welding device 1 includes a welding head 10, a collimator 11, an optical diffraction element 12, a condensing lens 13, a laser light source 14, an optical transmission unit 15, a powder supply source 16, and a shield gas supply source 17.

The welding head 10 irradiates a surface of the metal member with a laser beam while supplying a weld metal powder to the surface of the metal member. The welding head 10 is held by a moving mechanism (not shown) so that the entire welling head can move relative to the metal member in one direction.

An optical path 10a is formed in the welding head 10. When the welding device 1 performs the overlay welding, one end of the optical path 10a is open to a front end surface 10b facing the surface of the metal member of the welding bead 10. An opening portion of the optical path 10a is a light emission port 10c of the welding head 10. The optical path 10a guides a laser beam guided by the optical transmission unit 15 formed of an optical fiber or the like to the light emission port 10c. The optical transmission unit 15 connects the laser light source 14 such as a YAG laser or a fiber laser and the other end of the optical path 10a on a side opposite to the one end side to each other. The optical transmission unit 15 guides the laser beam from the laser light, source 14 into the optical path 10a.

In addition, a powder supply path 10d for supplying weld metal powder to the surface of the metal member is formed in the welding head 10. One end of the powder supply path 10d is open at the front end surface 10b of the welding head 10, and the other end of the powder supply path 10d is connected to the powder supply source 16. In addition, a shield gas supply path 10e for supplying a shield gas such as argon gas (Ar) of the like is formed in the welding head 10. One end of the shield gas supply path 10e is open at the front end surface 10b of the welding head 10, and the other end of the shield gas supply path 10e is connected to the shield gas supply source 17.

For example, a plurality of openings of the powder supply path 10d are arranged side by side on the front end surface 10b of the welding head 10. As shown in FIG. 1B, as an example, a case where openings of the three powder supply sources 16 are open at the front end surface 10b. In addition, the opening of the shield gas supply path 10e is formed in an annular shape on the front end surface 10b to surround the opening of the optical path 10a and the opening of the powder supply path 10d.

The collimator 11 is provided on the optical path 10a of the welling head 10. The collimator 11 converts the laser beam guided into the optical path 10a from the laser light source 14 through the optical transmission unit 15 into a laser beam of a parallel light my.

The optical diffraction element 12 (a diffractive optical element (DOB) is provided closer to the light emission port 10c side than the collimator 11 on the optical path 10a of the welding head 10. The optical diffraction element 12 shapes the laser beam of the parallel light ray into a beam-shaped laser beam by passing through the collimator 11, The optical diffraction element 12 of the present embodiment includes an optical diffraction grating 12a capable of shaping the parallel light ray from the collimator 11 into a long rectangular beam.

The condensing lens 13 is provided closer to the light emission port 10c side than the optical diffraction element 12 on the optical path 10a of the welding head 10. The condensing lens 13 collects the laser beam shaped by the optical diffraction element 12. The laser beam collected by the condensing lens 13 is emitted from the light emission port 10e through the optical path 10a, and the surface of the metal member is irradiated with the laser beam.

Hereinafter, a region where the surface of the metal member is irradiated with the laser beam is referred to as an irradiation region R. An example of a shape of the irradiation region R which can be virtually shown on the surface of the metal member is shown in FIG. 1B. The irradiation region R of the present embodiment has, for example, a rectangular shape.

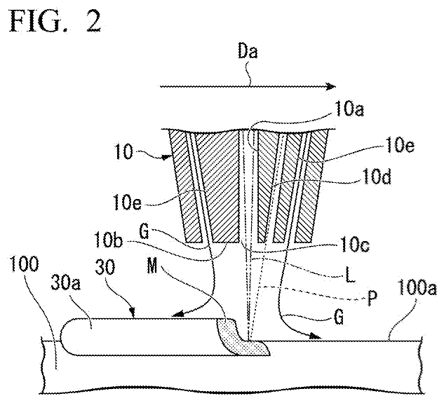

As shown in FIG. 2, the welling head 10 irradiates a surface 100a of a metal member 100 with a laser beam L while supplying a weld metal powder P to the surface 100a of the metal member 100. Accordingly, the supplied weld metal powder P is melted on the surface 100a of the metal member 100 by the laser beam L. and a molten pool M is formed in the irradiation region R. At this time, a shield gas G for suppressing a reaction between the molten pool M and surrounding air is supplied from the shield gas supply path 10e, and the supplied shield gas G flows around the molten pool M. The molten pool M is formed on the surface 100a of the metal member 100 and the welding head 10 is moved in one direction. Accordingly, a weld bead 30 extending in one direction is formed on the surface 100a of the metal member 100. Hereinafter, the one direction in which the welding head 10 is moved is referred to as a welding direction Da. The welding direction Da coincides with a direction in which a short side of the rectangular irradiation region R extends.

At this time, the weld bead 30 is formed on the surface 100a of the metal member 100 which is processed to perform the overlay welding. The weld bead 30 includes a surface 30a which does not come into contact with the surface 100a of the metal member 100. The surface 30a of the weld bead 30 formed on the surface 100a of the metal member 100 has a convex curved surface shape which is convex toward a side separated from the surface 100a of the metal member 100.

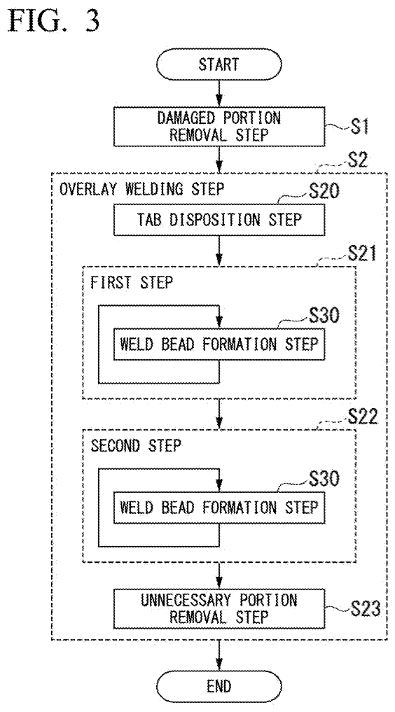

Next, a method for repairing the metal member 100 of the present embodiment will be described. As shown in FIG. 3, in the method for repairing the metal member 100, a damaged portion removal step S1 and an overlay welding step S2 are performed.

(Damaged Portion Removal Step)

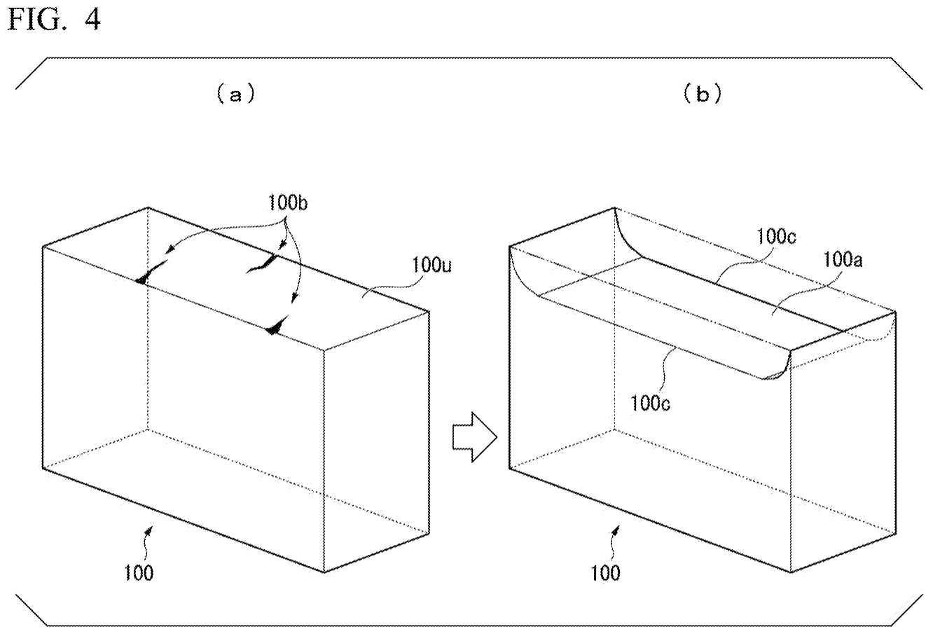

First, in the damaged portion removal step S1, a damaged portion of the metal member 100 is removed. Hereinafter, for convenience of description, the damaged portion of the metal member 100 is simply referred to as a “damaged portion 100b”. Specifically, as shown in FIG. 4, the damaged portion 100b is removed by cutting or grinding a portion of the metal member 100 to include a portion of an upper surface 100u of the surface of the metal member 100, where the damaged portion 100h such as a crack has occurred. In a case where the metal member 100 is a split ring of a gas turbine, for example, a side surface of the split ring can be an exemplary example of the upper surface 100u of the metal member 100.

To remove the damaged portion 100b, for example, a tool such as a grinder is used. In the damaged portion removal step S1, the damaged portion 100h is removed from the metal member 100, thereby forming the surface 100a which is a target portion of the overlay welding by the welding device 1.

As shown in FIG. 3, after the damaged portion removal step S1 ends, the overlay welding step S2 is subsequently performed.

(Overlay Welding Step)

In the overlay welding step S2, the overlay welding is performed on the surface 100a of the metal member 100, from which the damaged portion 100b is removed in the damaged portion removal step S1. In the overlay welding method of the present embodiment, a tab disposition step S20, a first step S21, a second step S22, and an unnecessary portion removal step S23 are performed.

(Tab Disposition Step)

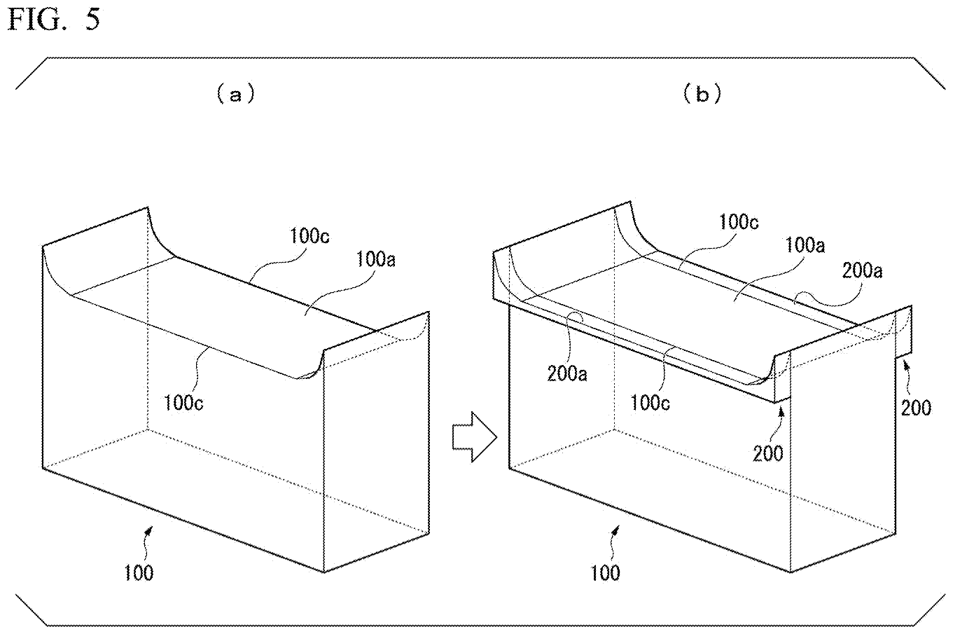

As shown in FIG. 5, in the tab disposition step S20, a tab 200 is provided along an edge 100c of the metal member 100. The tab 200 is a member for preventing the weld metal powder from falling from the surface 100a of the metal member 100 when the surface 100a of the metal member 100 is subjected to the overlay welding.

The tab 200 is provided along the edge 100c of the metal member 100 so that a surface 200a of the tab 200 is flush with the surface 100a of the metal member 100. The tab 200 is fixed to the metal member 100 by welding or the like, for example, to be integrated with the metal member 100. As shown in FIG. 3, after the tab disposition step S20 ends, the first step S21 is subsequently performed.

(First Step)

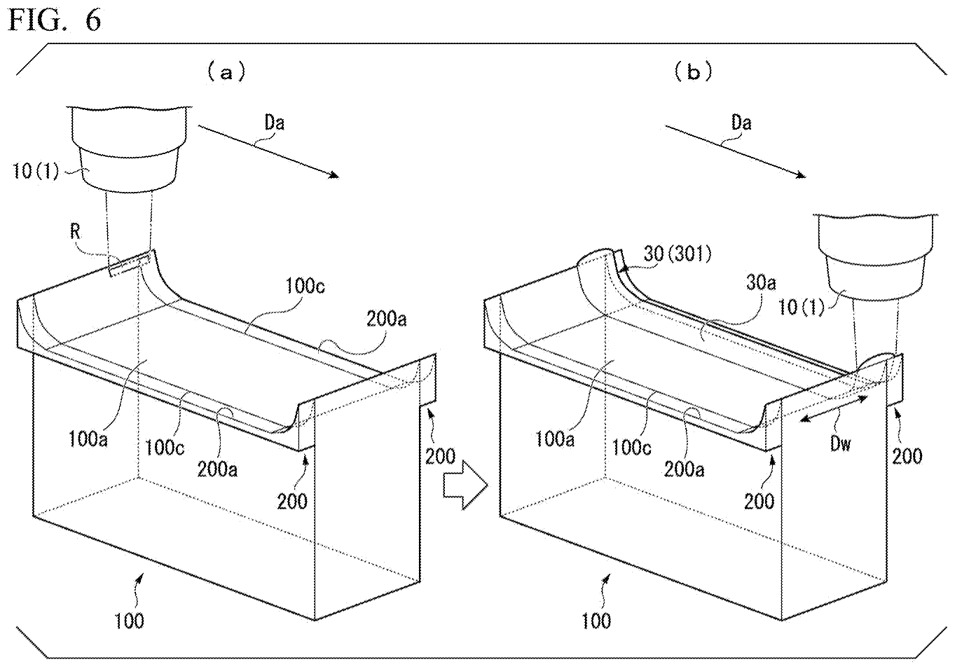

In the first step S21, a weld bead formation step S30 is repeatedly performed. As shown in FIG. 6, in the weld bead formation step S30, the molten pool M is formed with a laser beam, and the weld bead 30 formed by melting or solidifying the weld metal powder input to the molten pool M is formed on the surface 100a of the metal member 100. In the first step S21, a plurality of weld beads 30 are formed on the surface 100a of the metal member 100 by repeatedly performing the weld bead formation step S30. Hereinafter, for convenience of description, the plurality of weld beads 30 formed in the first step S21 are collectively referred to as a “weld bead group 30g”.

In the weld bead formation step S30, the surface 100a of the metal member 100 is irradiated with a laser beam, and the welding head 10 is moved in the welding direction Da while the weld metal powder is supplied to the surface 100a of the metal member 100. Therefore, the weld beads 30 extending in the welding direction Da are formed on the surface 100a of the metal member 100.

In the present embodiment, for convenience of description, among the plurality of weld beads 30 formed on the surface 100a of the metal member 100 by repeating the weld bead formation step S30, the weld bead 30 initially formed is referred to as a “first weld bead 301”. The first weld bead 301 formed in the weld bead formation step S30 straddles the surface 200a of the tab 200 and the surface 100a of the metal member 100.

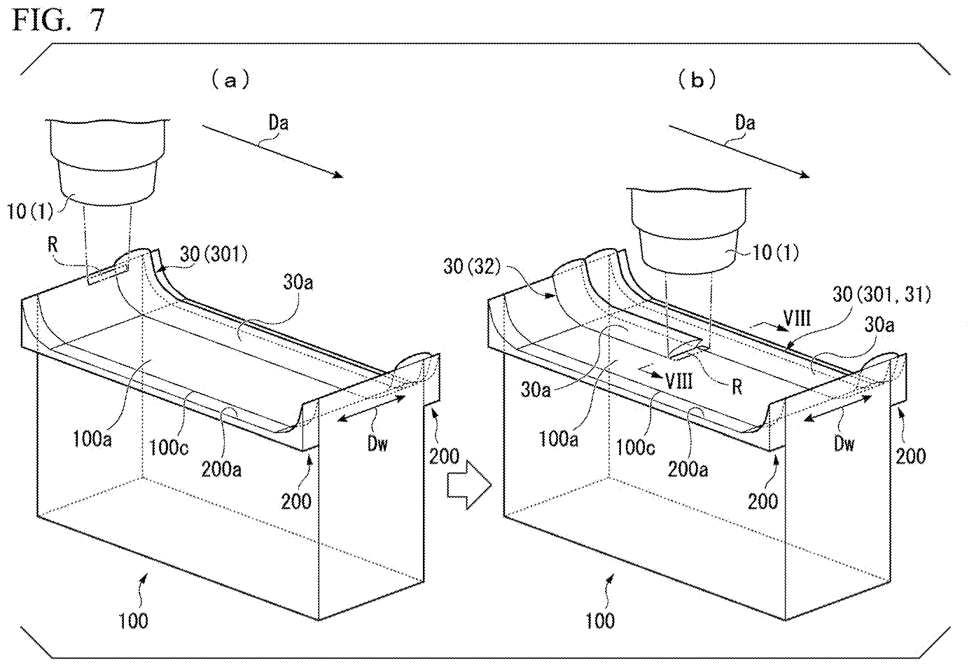

As shown in FIG. 7, after the formation of the first weld bead 301 ends, the weld bead 30 extending in the welding direction Da is formed in a state of being adjacent to the first weld bead 301. In the present embodiment, for convenience of description, when the weld bead 30 is formed, a previously formed weld bead 30 is referred to as a “preformed weld bead 31”, and a newly formed weld bead 30 is referred to as an “adjacent weld bead 32”. Therefore, the weld bead 30 which is secondly formed is the adjacent weld bead 32 with respect to the first weld bead 301 which is initially formed, which is the preformed weld bead 31.

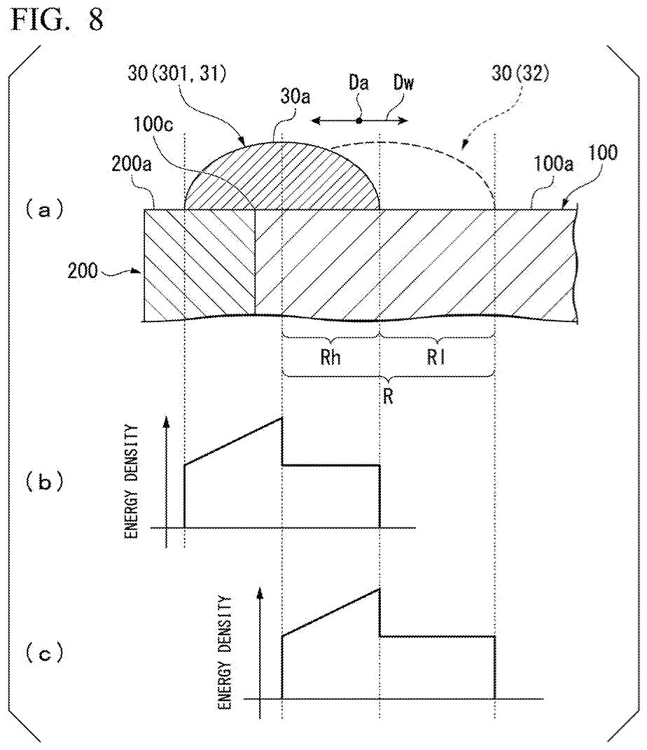

As shown in FIG. 8, for the adjacent weld bead 32 which is the secondly formed weld bead 30, and the first weld bead 301, portions of the weld bead 30 in a width direction Dw overlap each other. The width direction Dw of the weld bead 30 coincide with a direction in which a long side of the rectangular irradiation region R extends.

In addition, the adjacent weld bead 32 overlaps the first weld bead 301 to avoid a thickest portion of the surface 30a of the first weld bead 301. The term “thickest portion” used herein refers to a portion of the surface 30a of the weld bead 30 which is most separated from the surface 100a of the metal member 100.

Here, an energy density of the laser beam emitted from the welding head 10 in a case of forming the adjacent weld bead 32 is adjusted to be higher at a portion of the adjacent weld bead 32 overlapping the first weld bead 301 than a portion not overlapping the first weld bead 301.

In other words, the energy density of the portion of the irradiation region R where the first weld bead 301 is irradiated with the laser beam is higher than the energy density of the portion of the irradiation region R where the surface 100a of the metal member 100 is irradiated with the laser beam. That is, in the first step S21 of the present embodiment, while the weld bead formation step S30 is repeatedly performed, the energy density of the portion of the irradiation region R where the preformed weld bead 31 is irradiated with the laser beam is higher than the energy density of the portion of the irradiation region R where the surface 100a of the metal member 100 is irradiated with the laser beam.

Hereinafter, for convenience of description, the portion of the irradiation region R where the preformed weld bead 31 is irradiated with the laser beam is referred to as a “high energy region Rh”, and a portion of the irradiation region R excluding the high energy region Rh is referred to as a “low energy region R1”. In a case where the first weld bead 301 is formed on the surface 100a of the metal member 100, the high energy region Rh of the irradiation region R is formed in a state of being disposed on the surface 200a of the tab 200.

The energy density of the laser beam is adjusted by using the optical diffraction grating 12a included in the optical diffraction element 12 of the welding device 1. That is, the optical diffraction grating 12a is employed such that the energy density of the laser beam emitted from the welding head 10 is higher at a portion of the adjacent weld bead 32 overlapping the first weld bead 301 than a portion not overlapping the first weld bead 301.

In the present embodiment, the energy density of the laser beam in the overlapping portion of the adjacent weld beads 32 (the energy density of the laser beam in the high energy region Rh) shows a distribution which increases toward a side of a non-overlapping portion. More specifically, the energy density of the laser beam in the overlapping portion of the adjacent weld beads 32 shows a distribution which linearly increases toward a side of the non-overlapping portion.

On the other hand, the energy density of the laser beam in the non-overlapping portion of the adjacent weld beads 32 (the energy density of the laser beam in the low energy region R1) shows a uniform distribution in the width direction Dw of the weld bead 30.

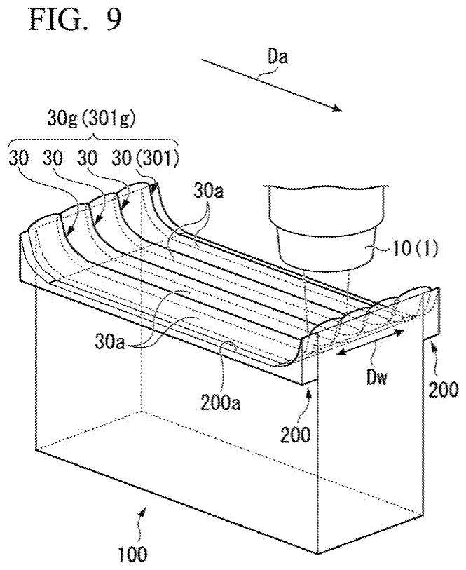

As shown in FIG. 9, in the first step S21, the weld bead group 30g is formed by repeating the weld bead formation step S30 twice or more. In FIG. 9, the weld bead group 30g formed in a case where the weld bead formation step S30 is repeated four times in the first step S21 is shown as an example. The weld bead group 30g consisting of the plurality of weld beads 30 covers the entire surface 100a of the metal member 100.

The weld bead 30 formed in a final weld bead formation step S30 in the first step S21 straddles over the surface 100a of the metal member 100 and the surface 200a of the tab 200. At this time, in a case where the weld bead 30 formed in the final weld bead formation step S30 in the first step S21 is formed on the surface 100a of the metal member 100, the low energy region R1 of the irradiation region R is formed in a state of being disposed to straddle the surface 100a of the metal member 100 and the surface 200a of the tab 200.

As shown in FIG. 3, after the first step S21 ends, the second step S22 is subsequently performed.

(Second Step)

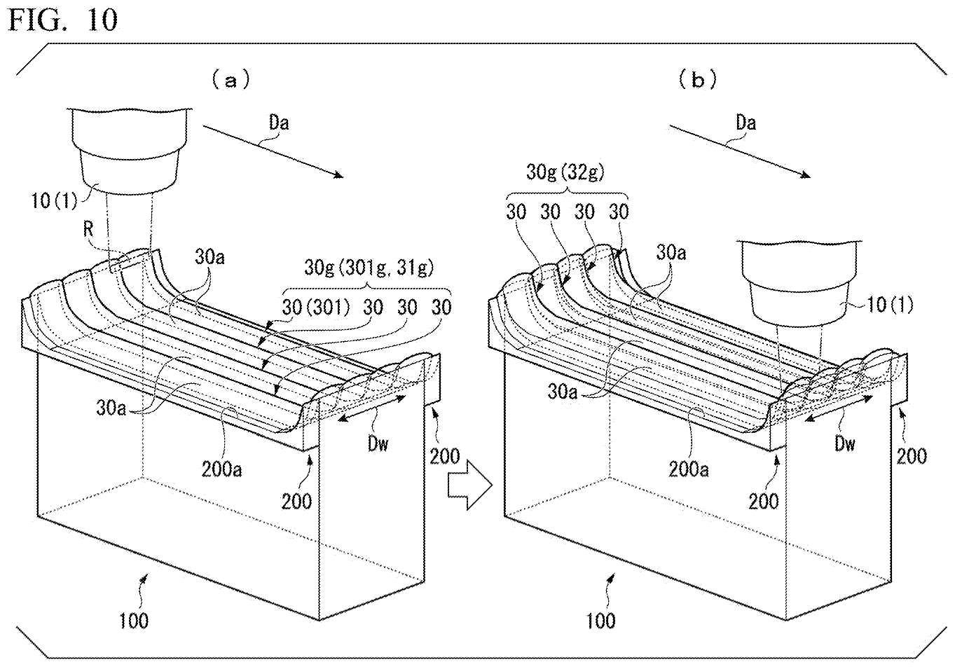

In the second step S22, a weld bead formation step S30 is repeatedly performed. As shown in FIG. 10, in the weld bead formation step S30 in the second step S22, the weld bead 30 formed by melting or solidifying the weld metal powder input to the molten pool M formed with the laser beam is formed on the surface 30a of the weld bead of the previously formed weld bead group 30g.

In the second step S22, the weld bead formation step S30 is repeatedly performed, thereby forming a plurality of the weld beads 30 on the weld bead group 30g formed in the first step S21. That is, in the second step S22, a new weld bead group 30g is formed on the weld bead group 30g formed in the first step S21. In FIG. 10, the new weld bead group 30g formed in a case where the weld bead formation step S30 is repeated four times in the second step S22 is shown as an example.

In the present embodiment, for convenience of description, the weld bead group 30g formed in the first step S21 is referred to as a “first weld bead group 301g”. In addition, in a case of forming the new weld bead group 30g on the previously formed weld bead group 30g, the previously formed weld bead group 30g is referred to as a “preformed weld bead group 31g” and the weld bead group 30g newly formed to form a layer on this preformed weld bead group 31g is referred to as a “superimposed weld bead group 32g”. Therefore, the weld bead group 30g which is initially formed in the second step S22 is the superimposed weld bead group 32g with respect to the first weld bead group 301g which is the preformed weld bead 31.

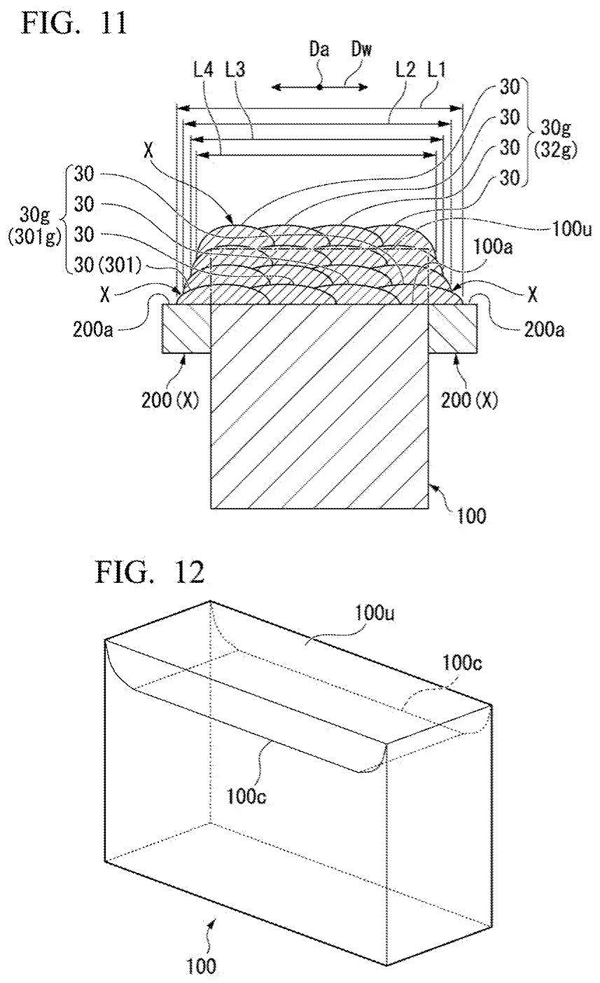

In the second step S22, after the superimposed weld bead group 32g is formed on the first weld bead group 301g, the new superimposed weld bead group 32g is formed to form a layer on the preformed weld bead group 31g, using the superimposed weld bead group 32g as the preformed weld bead group 31g. FIG. 11 shows, as an example, a case where a new three-layered weld bead group 30g is formed on the first weld bead group 301g formed in the first step S21.

Here, a dimension of the superimposed weld bead group 32g formed in the second step S22 in the width direction Dw is shorter than a dimension of the preformed weld bead group 31g in the width direction Dw. That is, as shown in FIG. 11, a dimension LI of the first weld bead group 301g in the width direction Dw formed in the first step S21 is longer than a dimension L2 of the superimposed weld bead group 32g in the width direction Dw with respect to the first weld bead group 301g initially formed in the second step S22. In addition, the dimension 12 of the preformed weld bead group 31g in the width direction Dw initially formed in the second step S22 is longer than a dimension L3 of the superimposed weld bead group 32g in the width direction Dw with respect to the preformed weld bead group 31g. In addition, the dimension L3 of the preformed weld bead group 31g in the width direction Dw secondly formed in the second step S22 is longer than a dimension LA of the superimposed weld bead group 32g in the width direction Dw with respect to the preformed weld bead group 31g. Therefore, the plurality of weld bead groups 30g forming layers together, which are formed in the second step S22, have the dimensions of the weld beads 30 in the width direction Dw decreasing as the weld bead groups are superimposed.

As shown in FIG. 3, after the second step S22 ends, the unnecessary portion removal step S23 is subsequently performed.

(Unnecessary Portion Removal Step)

In the unnecessary portion removal step S23, after the weld bead group 30g consisting of the plurality of weld beads 30 is formed in the second step S22, a portion of the weld bead 30 formed on the tab 200 is removed together with the tab 200 as an unnecessary portion X. In addition, in the unnecessary portion removal step S23, for example, the weld bead 30 raised above a position of the upper surface 100u of the metal member 100 before removing the damaged portion 100b is removed as the unnecessary portion X. For example, in FIG. 11, the portions of the metal member 100 and the weld beads 30 other than the region indicated by a two-dot chain line are shown as the unnecessary portion X.

Specifically, as shown in FIG. 12, in the unnecessary portion removal step S23, the unnecessary portion X is removed to have a shape of the metal member 100 before removing the damaged portion 100b. Accordingly, the metal member 100 including the weld beads 30 is restored to its original shape. To remove the unnecessary portion X, for example, a tool such as a grinder is used.

As the unnecessary portion removal step S23 ends, the overlay welding step S2 of performing the overlay welding method ends.

(Action Effect)

In a case where the weld bead 30 is formed on the surface 100a of the metal member 100, the surface 30a of the weld bead 30 forms a convex curved surface shape which is convex toward a side separated from the surface 100a of the metal member 100. In a case where the overlay welding is performed so that portions of the plurality of weld beads 30 in the width direction Dw overlap each other in a state of being adjacent to the weld beads 30 in the width direction Dw, the energy density of the laser beam emitted to the surface 30a of the preformed weld bead 31 is relatively lower than the surface 100a of the metal member 100 in a curved surface on the surface 30a. Therefore, the energy density of the laser beam may not be uniformly distributed in the width direction Dw of the weld beads 30, and the amount of heat input to the portion where the weld beads 30 overlap each other in the width direction Dw of the weld beads 30 may be insufficient.

According to the above description, the energy density of the laser beam in a case of forming the adjacent weld bead 32 is adjusted to be higher at a portion of the adjacent weld bead 32 overlapping the preformed weld bead 31 than a portion not overlapping the preformed weld bead 31. Therefore, the amount of heat input to the portion where the weld beads 30 overlap each other can be increased without increasing the energy density of the laser beam as a whole. Therefore, it is possible to suppress the occurrence of fusion failure in the portion where the weld beads 30 overlap each other while suppressing a thermal effect on the metal member 100.

In addition, according to the above description, since the energy density of the laser beam is adjusted by using the optical diffraction grating 12a, the above action can be realized with higher accuracy.

In addition, according to the above description, the tab 200 is provided along the edge 100c of the metal member 100 before the weld bead 30 is formed. Accordingly, for example, in a case where the weld bead 30 is formed on the surface 100a of the metal member 100, falling of the weld metal powder from the surface 100a of the metal member 100 is suppressed. In addition, after the plurality of weld beads 30 are formed, the portion of the weld beads 30 formed on the tab 200 is removed together with the tab 200. Therefore, it is possible to increase a thickness of the weld bead 30 at a portion of the edge 100c of the metal member 100.

In addition, according to the above description, the first weld bead 301, which is the weld bead 30 initially formed on the surface 100a of the metal member 100, is formed to straddle the metal member 100 and the tab 200. Accordingly, for example, in a case where the first weld bead 301 is formed, a portion of the first weld bead 301 formed by a portion of the well bead 30 having a high energy density of the laser beam in the width direction Dw can be removed together with the tab 200. That is, a portion of the first weld bead 301 having a comparatively large amount of heat input can be removed together with the tab 200. Therefore, it is not necessary to change the optical diffraction grating 12a between a case where the first weld bead 301 is formed and a case where the other weld beads 30 are formed.

In addition, according to the above description, the adjacent weld bead 32 overlaps the preformed weld bead 31 to avoid the thickest portion on the surface 30a of the preformed weld bead 31, and the energy density of the laser beam in the overlapping portion of the adjacent weld bead 32 shows a distribution that increases toward the side of the non-overlapping portion. That is, the energy density in a portion where the weld beads 30 overlap each other in a case of forming the adjacent weld bead 32 increases as an inclination of the surface 30a of the preformed weld bead 31 in the width direction Dw becomes steeper. That is, a distribution corresponding to the shape of the surface 30a of the preformed weld bead 31 is shown. Accordingly, the heat can be input more appropriately, compared to a case where a uniform distribution is shown in the width direction Dw of the weld bead 30, for example. As a result, it is possible to suppress the occurrence of fusion failure in the portion where the weld beads 30 overlap each other.

### Other Embodiments

As described above, the embodiments of the present disclosure have been described in detail with reference to the drawings. However, the specific configuration is not limited to the configurations in the embodiments and additions, omissions, substitutions, and other modifications can be made without departing from the scope of the present disclosure.

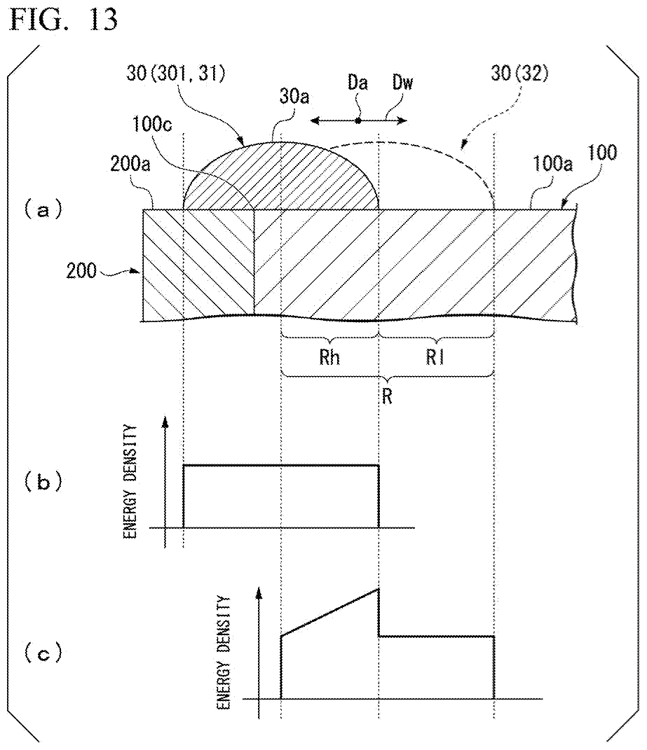

As shown in FIG. 13, in a case of forming the first weld bead 301 in the first step S21, the optical diffraction grating 12a in which the energy density of the laser beam of the first weld bead 301 in the width direction Dw is adjusted to be uniform may be used. At this time, for example, between a case of forming the first weld bead 301 and a case of forming the other weld bead 30, different optical diffraction gratings 12a may be used by an operation of changing the optical diffraction element 12 of the welding device 1. In addition, for example, two welding devices 1 may be prepared, and these welding devices 1 may include the optical diffraction elements 12 having different optical diffraction gratings 12a. Accordingly, a portion having a comparatively large amount of beat input in the first weld bead 301 is not generated.

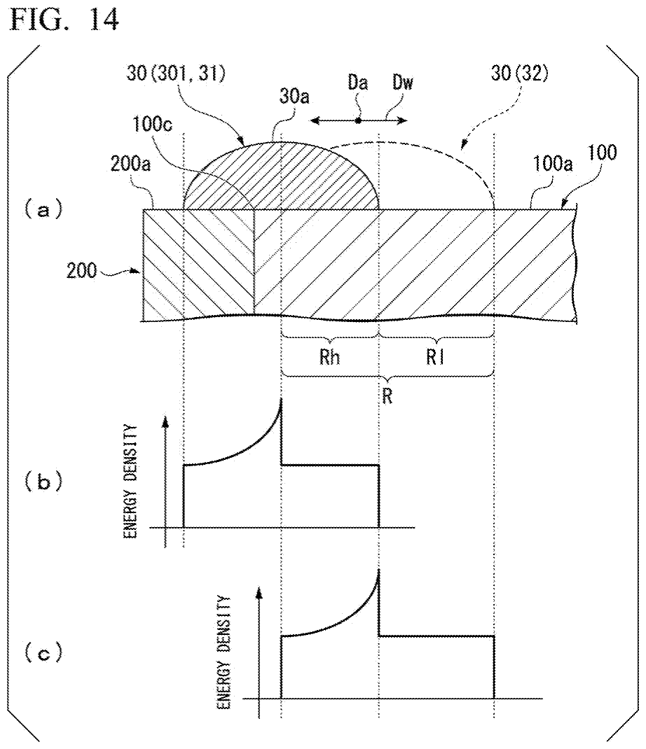

In addition, as shown in FIG. 14, in a case of forming the plurality weld beads in the first step S21, the energy density of the laser beam of the overlapping portion in the adjacent weld bead 32 may show a distribution which exponentially increases toward a side of the non-overlapping portion. Accordingly, the heat input can be performed more appropriately.

### APPENDIX

The overlay welding method and the method for repairing the metal member in the above embodiments are, for example, as follows.

(1) An overlay welding method of a first aspect is an overlay welding method including irradiating a surface 100a of a metal member 100 with a laser beam while supplying a weld metal powder, and performing overlay welding on the surface 100a of the metal member 100, in which a weld bead formation step S30 of melting and solidifying the weld metal powder with the laser beam to form a weld bead 30 on the surface 100a of the metal member 100 is repeatedly performed to form a plurality of weld beads 30 on the surface 100a of the metal member 100, each of the plurality of weld beads 30 has one portion in a width direction Dw overlapping each other, and in a case of forming an adjacent weld bead 32, which is a weld bead 30 adjacent to a previously formed weld bead 30, an energy density of the laser beam is adjusted to be higher at a portion of the adjacent weld bead 32 overlapping the previously formed weld bead 30 than a portion not overlapping the previously formed weld bead 30.

Therefore, the amount of heat input to the portion where the weld beads 30 overlap each other can be increased without increasing the energy density of the laser beam as a whole.

(2) In the overlay welding method of a second aspect, in the overlay welding method of (1), the energy density of the laser beam may be adjusted using an optical diffraction grating 12a.

Therefore, the above action can be realized with higher accuracy.

(3) In the overlay welding method of a third aspect, in the overlay welding method of (2), a tab disposition step S20 of providing a tab 200 along an edge 100c of the metal member 100 before the weld bead formation step S30 is performed, and an unnecessary portion removal step S23 of removing a portion of the weld bead 30 formed on the tab 200 together with the tab 200, after the plurality weld beads 30 are formed, may be performed.

Accordingly, in a case where the weld bead 30 is formed on the surface 100a of the metal member 100, falling of the weld metal powder from the surface 100a of the metal member 100 is suppressed. In addition, it is possible to increase a thickness of the weld bead 30 at a portion of the edge 100c of the metal member 100.

(4) In the overlay welding method of a fourth aspect, in the overlay welding method of (3), a first weld bead 301, which is an initially formed weld bead 30 among the plurality of weld beads 30, may be formed to straddle the metal member 100 and the tab 200.

Accordingly, for example, in a case where the first weld bead 301 is formed, a portion of the first weld bead 301 formed by a portion of the weld bead 30 having a high energy density of the laser beam in the width direction Dw can be removed together with the tab 200.

(5) In the overlay welding method of a fifth aspect, in the overlay welding method of (2), in a case of forming a first weld bead 301, which is an initially formed weld bead 30 among the plurality of weld beads 30, an optical diffraction grating 12a in which the energy density of the laser beam of the first weld bead 301 in the width direction Dw is adjusted to be uniform, may be used, and in a case of forming a weld bead 30 excluding the first weld bead 301 among the plurality weld beads 30, an optical diffraction grating 12a in which the energy density of the laser beam is adjusted to be higher at a portion of the adjacent weld bead 32 overlapping the previously formed weld bead 30 than a portion not overlapping the previously formed weld bead 30 may be used.

Accordingly, a portion having a comparatively large amount of heat input in the first weld bead 301 is not generated.

(6) In the overlay welding method of a sixth aspect, in the overlay welding method of any one of (1) to (4), the adjacent weld bead 32 may overlap the previously formed weld bead 30 to avoid a thickest portion of the surface 30a of the previously formed weld bead 30, and the energy density of the laser beam of the overlapping portion of the adjacent weld bead 32 may show a distribution which increases toward a side of the non-overlapping portion.

Accordingly, the heat input can be performed more appropriately.

(7) In a method for repairing a metal member 100 of a seventh aspect, a damaged portion removal step S1 of removing a damaged portion in the metal member 100, and an overlay welding step S2 of performing the overlay welding method of any one of (1) to (5) with respect to a surface 100a of the metal member 100, from which the damaged portion is removed, are performed.

While preferred embodiments of the invention have been described and illustrated above, it should be understood that these are exemplary of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.

### EXPLANATION OF REFERENCES

1: welding device
10: welding head
10a: optical path
10b: front end surface
10c; light emission port
10d: powder supply path
10e: shield gas supply path
11: collimator
12: optical diffraction element
12a: optical diffraction grating
13: condensing lens
14: laser light source
15: optical transmission unit
16: powder supply source
17: shield gas supply source
30: weld bead
30a, 100a, 200a: surface
30g: weld bead group
31: preformed weld bead
31g: preformed weld bead group
32: adjacent weld bead
32g: superimposed weld bead group
100: metal member
100b: damaged portion
100c: edge
100u; upper surface
200: tab
301; first weld bead
301g: first weld bead group
Da: welding direction
Dw; width direction
G: shield gas
L: laser beam
M: molten pool
P: weld metal ponder
R: irradiation region
Rh: high energy region
R1: low energy region
S1: damaged portion removal step
S2: overlay welding step
S20: tab disposition step
S21: first step
S22; second step
S23: unnecessary portion removal step
S30: weld bead formation stop
X: unnecessary portion

What is claimed is:

1. An overlay welding method, comprising:
irradiating a surface of a metal member with a laser beam while supplying a weld metal powder; and
performing overlay welding on the surface of the metal member,
wherein a weld bead formation step of melting and solidifying the weld metal powder with the laser beam to form a weld bead on the surface of the metal member is repeatedly performed to form a plurality of weld beads on the surface of the metal member,
each of the plurality of weld beads has one portion in a width direction overlapping each other, and
in a case of forming an adjacent weld bead, which is a weld bead adjacent to a previously formed weld bead, an energy density of the laser beam is adjusted to be higher at a portion of the adjacent weld bead overlapping the previously formed weld bead than at a portion not overlapping the previously formed weld bead.

2. The overlay welding method according to claim 1,
wherein the energy density of the laser beam is adjusted using an optical diffraction grating.

3. The overlay welding method according to claim 2,
wherein a tab disposition step of providing a tab along an edge of the metal member before the weld bead formation step is performed, and an unnecessary portion removal step of removing a portion of the weld bead formed on the tab together with the tab, after the plurality weld beads are formed, are performed.

4. The overlay welding method according to claim 3,
wherein a first weld bead, which is an initially formed weld bead among the plurality of weld beads, is formed to straddle the metal member and the tab.

5. The overlay welding method according to claim 2,
wherein, in a case of forming a first weld bead, which is an initially formed weld bead among the plurality of weld beads, an optical diffraction grating is used in which the energy density of the laser beam of the first weld bead in the width direction is adjusted to be uniform, and
in a case of forming a weld bead excluding the first weld bead among the plurality weld beads, an optical diffraction grating is used in which the energy density of the laser beam is adjusted to be higher at a portion of the adjacent weld bead overlapping the previously formed weld bead than at a portion not overlapping the previously formed weld bead.

6. The overlay welding method according to claim 1,
wherein the adjacent weld bead overlaps the previously formed weld bead to avoid a thickest portion of a surface of the previously formed weld bead, and
the energy density of the laser beam of the overlapping portion of the adjacent weld bead shows a distribution which increases toward a side of the non-overlapping portion.

7. A method for repairing a metal member, the method comprising:
a damaged portion removal step of removing a damaged portion in the metal member; and
an overlay welding step of performing the overlay welding method according to claim 1 with respect to a surface of the metal member, from which the damaged portion is removed.
